(19) United States
(12) Patent Application Publication
(10) Pub. No.: US 2002/0084223 A1
(43) Pub. Date: Jul. 4, 2002

(54) Removal of sulfur from naphtha streams using high silica zeolites

(76) Inventors: Joseph L. Feimer, Bright's Grove (CA); David N. Zinkie, Sarnia (CA)

Correspondence Address: Gerard J. Hughes, ExxonMobil Research and Engineering Company, P.O. Box 900, Annandale, NJ, 08801-0900, US

(21) Appl. No.: 10/023,002

(22) Filed: Dec. 17, 2001

Related U.S. Application Data
(60) Provisional application No. 60/258,506, filed on Dec. 28, 2000.

(51) Int. Cl. B01D 15/00

(52) U.S. Cl. 210/660

(57) ABSTRACT

A method of removing low boiling sulfur compounds from naphtha boiling range streams. The naphtha boiling range stream is contacted with a high silica zeolite at effective conditions to convert lower boiling sulfur compounds to higher boiling sulfur compounds. The naphtha stream is then fractionated into a lower boiling stream having substantially reduced levels of sulfur compounds and a higher boiling range fraction containing the higher boiling sulfur compounds.

### CROSS REFERENCE TO RELATED APPLICATIONS

This application claims benefit of Provisional U.S. Application Serial No. 60/258,506 filed Dec. 28, 2000.

### FIELD OF THE INVENTION

The present invention relates to a method of removing low boiling sulfur compounds from naphtha boiling range streams. The naphtha boiling range stream is contacted with a high silica zeolite at effective conditions to convert lower boiling sulfur compounds to higher boiling sulfur compounds. The naphtha stream is then fractionated into a lower boiling stream having substantially reduced levels of sulfur compounds and a higher boiling range fraction containing the higher boiling sulfur compounds.

### BACKGROUND OF THE INVENTION

The presence of sulfur compounds in petroleum fractions is highly undesirable since they result in corrosion and environmental problems. These compounds are also responsible for reducing the performance of engines using such fuels. It has not been considered advisable in the past to transport refined hydrocarbon fluids in a pipeline used for the transportation of sour hydrocarbon fluids, such as petroleum crudes. The major reason is that refined hydrocarbon fluids, such as gasoline and diesel fuel, pick-up contaminants such as elemental sulfur. Between about 10 to 80 mg/L elemental sulfur is picked-up by gasoline and between about 1 to 20 mg/L elemental sulfur is picked-up by diesel fuel when pipelined. Sulfur has a particularly corrosive effect on equipment, such as brass valves, gauges, silver bearings cages in two-cycle engines and in-tank fuel pump copper commutators.

Furthermore, the maximum sulfur level allowable in gasoline in the U.S. is 350 wppm. By 2004 the sulfur level in motor gasoline will be legislated to less than 30 wppm. Auto emissions is one of the highest sources of atmospheric contaminants. Although significant changes in engine design have reduced the total emissions they have not changed the sulfur emissions.

Refiners have a number of options to produce lower sulfur gasoline. For example, they can refine lower sulfur crude. They can also hydrotreat refinery streams to remove contaminants or use processes that include adsorption and absorption.

Hydrodesulfurization is the conventional hydrotreating method for removal of sulfur compounds from hydrocarbon streams. In typical hydrodesulfurization processes, a portion of the sulfur components are removed from a hydrocarbon feed stream by reaction of the sulfur components with hydrogen gas in the presence of a suitable catalyst to form hydrogen sulfide. The resulting product is cooled and separated into a gas phase and a liquid phase, and the off-gas containing hydrogen sulfide can be discharged to a Claus plant for further processing. Hydrodesulfurizing processes that treat FCC gasoline, the major sulfur source in U.S. refinery gasoline, are characterized by both an undesirable high rate of hydrogen consumption (due to olefin saturation) and a significant octane degradation. Also, these processes require severe conditions, such as high temperatures up to about 425° C. as well as pressures up to about 3000 psig.

Gonzales et al. (“Can You Make Low-Sulfur Fuel and Remain Competitive,” Hart's Fuel Technology and Management, November/December 1996) indicate that cat feed desulfurization can reduce sulfur levels in cracked naphtha to 500 wppm. However, this is an expensive option, especially if a refiner cannot take advantage of the higher gasoline conversions as a result of cat feed desulfurization. Sulfur levels lower than about 200 wppm are achievable via hydrodesulfurization of light cracked-naphtha. However, this is incrementally even more expensive than cat feed desulfurization because of the high hydrogen consumption and loss of octane due to the hydrogenation of olefins. Thus, the hydrotreated cracked-naphtha needs to undergo an isomerization step to recover some of the octane.

Caustic extraction processes, such as the Merox process, is capable of extracting sulfur from hydrocarbon feedstreams, which sulfur is in the form of mercaptan compounds. The Merox process was announced to the industry in 1959. The Oil & Gas J. 57(44), 73-8 (1959) contains a discussion of the Merox process and also of some prior art processes. The Merox process uses a catalyst that is soluble in caustic, or alternatively is held on a support, to oxidize mercaptans to disulfides in the presence of oxygen and caustic. Mercaptans are corrosive compounds that must be extracted, or converted, to meet an industry standard copper strip test. Sodium mercaptans are formed which are soluble in caustic solution. The caustic solution, containing the mercaptan compounds, is warmed and then oxidized with air in the presence of a catalyst in a mixer column that converts the mercaptan compounds to the corresponding disulfides. The disulfides, which are not soluble in the caustic solution, can be separated and recycled for mercaptan extraction. The treated hydrocarbon stream is usually sent to a water wash in order to reduce the sodium content.

Such caustic extraction processes, however, are capable of extracting sulfur only in the form of light mercaptan compounds (for example, C₁ to C₄ mercaptans) that typically accounts for less than about 10% of the sulfur present in a FCC gasoline. Caustic extraction is able to remove only lighter boiling mercaptans while other sulfur components, such as sulfides and thiophenes, remain in the treated product streams. Also, oxygen compounds (e.g., phenols, carboxylic acids, peroxides) and nitrogen compounds (e.g., amines or nitrites) also found in FCC gasoline, are not appreciably affected by the Merox process. Problems associated with caustic extraction include: generation of hazardous liquid waste streams, such as spent caustic (which is classified as hazardous waste); smelly gas streams which arise from the fouled air effluent resulting from the oxidation step; and the disposal of the disulfide stream. Further, Merox processing problems include difficulties associated with handling a sodium and water contaminated product.

Adsorption is often a cost-effective process to remove low levels of contaminants. Salem, A. B. et al., “Removal of Sulfur Compounds from Naphtha Solutions Using Solid Adsorbents,” Chemical Engineering and Technology, Jun. 20, 1997) report a 65% reduction in the sulfur level (500 to 175 wppm) for a 50/50 mixture of virgin and cracked naphthas using activated carbon at 80° C. and a 30% reduction using Zeolite 13X at 80° C. Also, U.S. Pat. No. 5,807,475 teaches that Ni or Mo exchanged zeolite X and Y can be used to remove sulfur compounds from hydrocarbon streams. Typical adsorption processes have an adsorption cycle whereby the contaminant is adsorbed from the feed followed by a desorption cycle whereby the contaminant is removed from the adsorbent.

In spite of the limitations, the above mentioned processes, for the most part, provide satisfactory means for reducing the level of pollutants present in refinery hydrocarbon transportation fuel feedstocks to levels which were previously acceptable. These processes are not, however, suited for the economic reduction of heteroatom pollutants in transportation fuel feedstocks to the new and substantially lower levels that are now, or will soon be, required by governmental regulations. Thus, there is a need in the art for improved processes that can meet these stricter regulations.

### SUMMARY OF THE INVENTION

In accordance with the present invention, there is provided a method for reducing the level of sulfur in naphtha boiling range streams containing low boiling sulfur compounds, comprising:

(a) contacting said naphtha boiling range stream with a high silica, large pore zeolite at effective conditions to convert at least a portion of said lower boiling sulfur compounds to higher boiling sulfur compounds;

(b) fractionating the contacted naphtha boiling range stream into a lower boiling range fraction and a higher boiling range fraction, said lower normal boiling range fraction boiling below about 150° C., and said higher boiling range fraction containing the higher boiling range sulfur compounds.

In a preferred embodiment of the present invention, the ratio of silica to alumina of said high silica zeolite is at least 10% greater than the base zeolite.

In yet another preferred embodiment of the present invention the base zeolite has a unit cell size greater than about 6 Å in diameter.

In still another preferred embodiment of the present invention the base zeolite is a faujasite.

In another preferred embodiment of the present invention, the boiling range of the naphtha stream to be treated is from about 35° C. to about 220° C.

### BRIEF DESCRIPTION OF THE FIGURES

FIG. 1A hereof is the chromatograms of the sulfur-specific analysis for untreated Dartmouth light cat cracked naphtha of Example 1 hereof.

FIG. 1B hereof is the chromatograms of the sulfur-specific analysis for treated Dartmouth light cat cracked naphtha of Example 1 hereof.

FIG. 2A hereof is the chromatograms of the sulfur-specific analysis for the untreated Sarnia cat cracked naphtha of Example 2 hereof.

FIG. 2B hereof is the chromatograms of the sulfur-specific analysis for the treated Sarnia cat cracked naphtha of Example 2 hereof.

FIG. 3 hereof are the chromatograms of the sulfur-specific analysis for the Dartmouth light cat cracked naphtha treated in accordance with Example 3 hereof.

### DETAILED DESCRIPTION OF THE INVENTION

Naphtha boiling range streams can comprise any one or more refinery streams boiling, at about atmospheric pressure, in the range from about 10° C. to about 230° C., preferably from about 100° C. to about 220° C., more preferably from about 135° C. to about 220° C. The naphtha boiling range stream generally contains cracked naphtha which typically comprises fluid catalytic cracking unit naphtha (FCC catalytic naphtha, or cat cracked naphtha), coker naphtha, hydrocracker naphtha, resid hydrotreater naphtha, debutanized natural gasoline (DNG), and gasoline blending components from other sources wherein a naphtha boiling range stream can be produced. FCC catalytic, naphtha and coker naphtha are generally more olefinic naphthas since they are products of catalytic and/or thermal cracking reactions, and are the more preferred streams to be treated in accordance with the present invention. The sulfur content of the cat cracked naphtha stream will generally range from about 0.05 wt. % to about 0.7 wt. % and more typically from about 0.07 wt. % to about 0.5 wt. % based on the total weight of the feedstock. These naphtha feedstreams will generally contain sulfur compounds that need to be removed because or their corrosive nature and because of ever stricter environmental regulations. Non-limiting examples of sulfur compounds contained in such feedstocks include elemental sulfur, aliphatic, naphthenic, and aromatic mercaptans, sulfides, di- and polysulfides; thiophenes and their higher homologs and analogs.

Zeolites suitable for use herein are those having a relatively high silica-to-alumina ratio and having a unit cell size greater than about 6 Å in diameter. By relatively high silica-to-alumina we mean that the ratio of silica-to-alumina is at least about 10%, preferably at least about 50%, greater than the base zeolite. For example, the base zeolite “faujasite Y” typically has a silica-to-alumina ratio of 2, whereas the high silica version will have a silica-to-alumina ratio of at least about 4. Non-limiting examples of base natural zeolites include gmelinite, chabazite, dachiardite, clinoptilolite, faujasite, heulandite, levynite, erionite, cancrinite, scolecite, offretite, mordenite, and ferrierite. Included among the synthetic zeolites are zeolites X, Y, L, ZK-4, ZK-5, E, H, J, M, Q, T, Z, alpha and beta, ZSM-types and omega. Preferred are the faujasites, particularly zeolite Y and zeolite X, more preferably those having a unit cell size greater than 6 Å in diameter. For example, Zeolite Y and X have a unit cell size of approximately 13 Å which is large enough to allow sulfur molecules to enter, and larger converted sulfur molecules to leave.

The present invention is generally practiced by contacting the sulfur-containing naphtha stream with an effective amount of the high silica zeolites, for an effective period of time. By effective amount of high silica zeolite we mean at least that amount of zeolite that will convert at least 50 wt. %, preferably at least about 75 wt. %, and more preferably greater than about 90 wt. % of the lower boiling sulfur compounds to higher boiling sulfur compounds under reaction conditions. Reaction conditions include temperatures from about −30° C. to about 300° C., preferably from about 0° C. to about 100° C., and pressures from about atmospheric to about 500 psig, preferably from about atmospheric pressure to about 200 psig. By lower boiling fraction we mean that fraction boiling below about 150° C., preferably below about 100° C. After contacting is complete and a predetermined amount of the lower boiling sulfur compounds are converted to higher boiling sulfur compounds the treated naphtha feedstream is fractionated into a lower boiling fraction and a higher boiling fraction. The higher boiling fraction will contain the higher boiling sulfur compounds that were converted from the lower boiling sulfur compounds. The lower boiling fraction will contain a substantially lower level of sulfur compounds. The resulting lower boiling fraction is suitable for blending into the mogas pool and will not require expensive hydrotreating that consumes hydrogen, saturates olefins and reduces the octane level. The higher boiling fraction will require hydrotreating, such as hydrodesulfurization, to remove enough sulfur so that it can also be used as blending stock for the mogas pool. Unlike the lower boiling naphtha fraction, the higher boiling naphtha fraction does not contain many olefins and therefore does not lose octane during hydrotreating.

The higher boiling fraction can be subjected to conventional hydrodesulfurization to remove at least a fraction of the sulfur. Hydrodesulfurization is the conventional method for effective removal of sulfur compounds. In typical hydrodesulfurization processes, a portion of the sulfur components are removed from a hydrocarbon feed stream by reaction of the sulfur components with hydrogen gas in the presence of a suitable catalyst to form hydrogen sulfide. Suitable catalysts are typically those comprised of a least one Group VIII metal, such as nickel or cobalt and at least one Group VI metal such as molybdenum or tungsten, on a refractory support. Groups VIII and VI refer to the Period Table of the Elements. Hydrogen sulfide can be removed from the product gas stream by use of a wash solvent (such as amine) followed by conversion of the hydrogen sulfide to elemental sulfur in a Claus plant.

It is within the scope of this invention that the conversion of lower boiling sulfur compounds to higher boiling sulfur compounds and the fractionation of the two fractions take place in separate vessels. For example, the conversion of the sulfur compounds can take place in a reaction vessel and the entire stream passed to a fractionation vessel wherein at least two streams are produced based on boiling point. It is also within the scope of this invention that the conversion step and the fractionation step take place in a single vessel. For example, the vessel can be a distillation vessel wherein a fall cut naphtha is fed to a distillation column wherein a low boiling fraction and a higher boiling fraction are produced. The lower boiling fraction rises through a bed of high silica zeolite wherein lower boiling sulfur compounds are converted to higher boiling compounds, which end up in the higher boiling fraction. As previously mentioned, the higher boiling fraction, that can contain a relatively high level of sulfur compounds, is passed to a hydrodesulfurization process unit before it can be used as blending stock for the mogas pool.

This invention will be illustrated by the examples that follow, which examples are not intended to be limiting in any way.

### EXAMPLES

### Example 1

A glass column was filled with 60 grams of high silica zeolite having a silica-to-alumina ratio of 4:1 (UOP HISIV-1000) and then flooded with 80 cc of light cat naphtha from Dartmouth, Canada (DLCN). The DLCN had a boiling range from about C₅ to 250° F. The column was kept at room temperature (22° C.) for 3 hours. The treated DLCN was then drained from the column. The sulfur composition in the untreated and treated DLCN was determined using sulfur-specific gas chromatography.

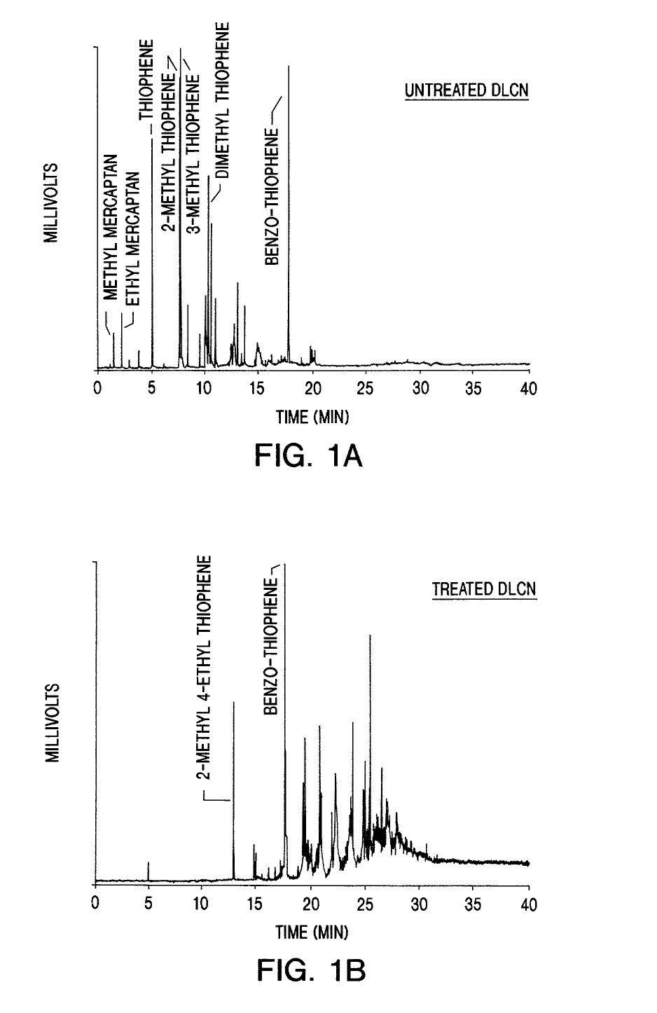

The chromatograms from the sulfur-specific analysis are illustrated in FIG. 1 hereof. The sulfur compounds elute from the column as a function of boiling point, with the lower boiling point compounds eluting first. As shown, the sulfur compounds in the untreated DLCN primarily boil between methyl mercaptan and benzo-thiophene. On the other hand, the sulfur compounds in the treated DLCN have boiling points greater than 2-methyl-4-ethyl thiophene. These chromatograms clearly show the conversion of light sulfur compounds to heavy sulfur compounds. The total sulfur level in DLCN is 750 wppm while the treated DLCN contains only 37 wppm total sulfur boiling below benzo-thiophene. This represents a 95% reduction in the light sulfur compounds.

### Example 2

A glass column was filled with 60 grams of high silica zeolite having a silica-to-alumina ratio of 4:1 (UOP HISIV-1000), then flooded with 82 cc of full boiling range cat naphtha from Sarnia, Canada (SCN). The SCN had a boiling range from about C₅ to 450° F. The column was kept at about room temperature for 3 hours. The treated SCN was then drained from the column. The sulfur composition in the untreated and treated SCN was determined using sulfur-specific gas chromatography.

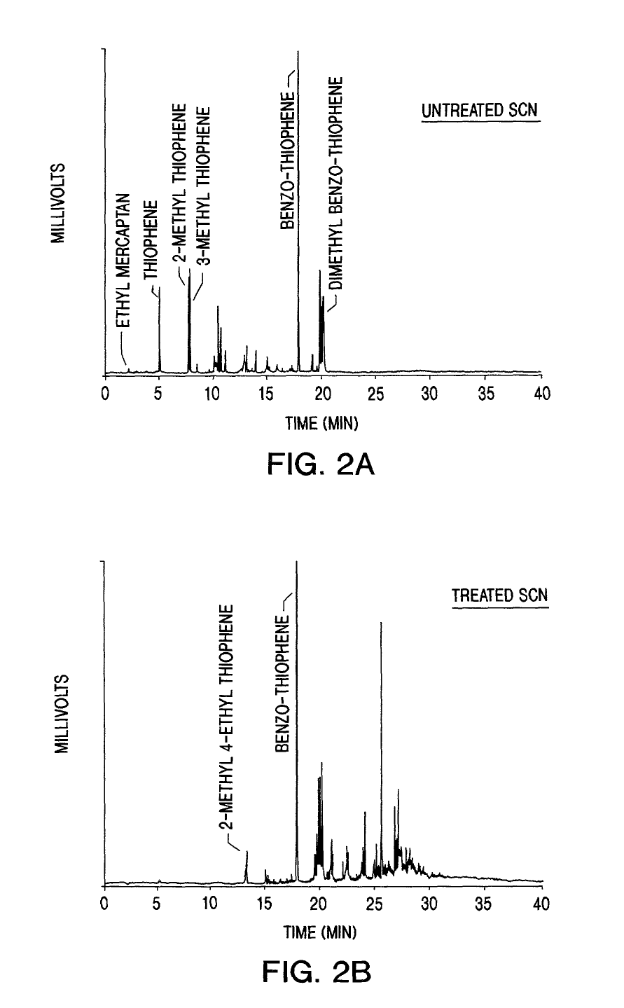

The chomatograms from the sulfur-specific analysis are illustrated in FIG. 2 hereof. As shown, the sulfur compounds in the untreated SCN largely boil between methyl mercaptan and dimethyl benzo-thiophene. On the other hand, the sulfur compounds in the treated SCN have boiling points greater than benzo-thiophene. Again, these chromatograms clearly show the conversion of lower boiling sulfur compounds to higher boiling sulfur compounds. The total sulfur level in SCN is about 2000 wppm while the treated SCN only contains 60 wppm total sulfur below benzo-thiophene. This represents a 97% reduction in the light sulfur compounds.

### Example 3

A glass column was filled with 100 grams of standard Na13X with a silicon-to-alumina ratio of approximately 1. The Na13X was then flooded with 100 cc of light cat naphtha from Dartmouth (DLCN). The DLCN had a boiling range from C₅ to 250° F. The column was kept at room temperature for 3 hours. The treated DLCN was then drained from the column. The sulfur composition in the untreated and treated DLCN was determined using sulfur-specific gas chromatography.

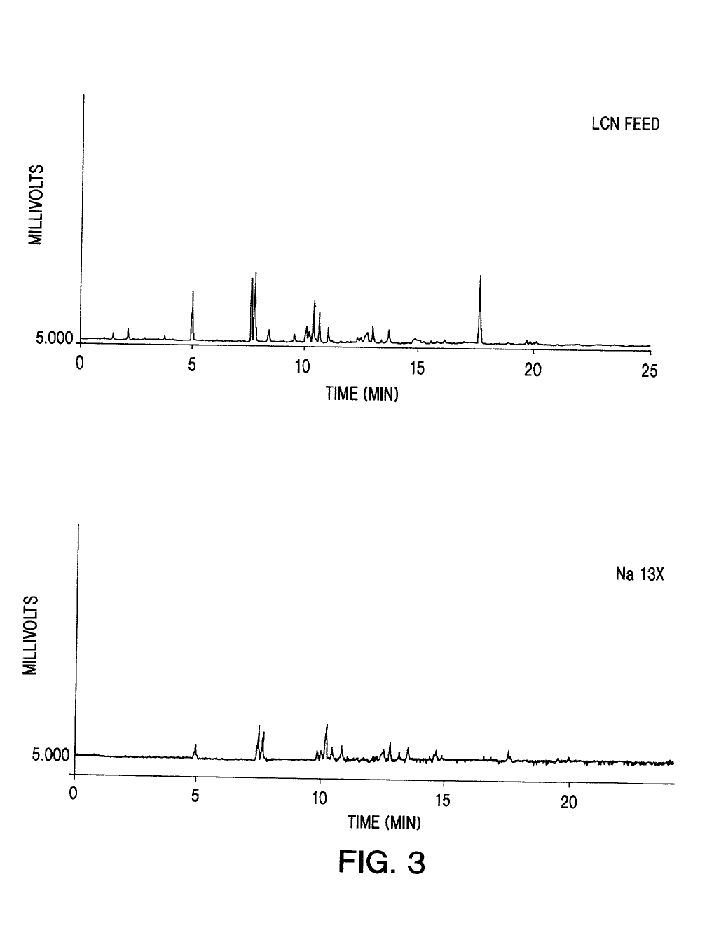

The chomatograms from the sulfur-specific analysis are illustrated in FIG. 3 hereof. The sulfur compounds elute from the column as a function of boiling point, with the lower boiling point compounds eluting first. As shown, although the total sulfur level in the treated product is lower than in feed (81 vs. 760 wppm) the sulfur compounds in the treated DLCN are the same as found in the feed indicating that no conversion of sulfur compounds occurred. Instead, some sulfur compounds were simply adsorbed onto Na13X and, unlike with the high silica-alumina faujasites, were not converted to higher molecular weight compounds.

1. A method for reducing the level of sulfur in naphtha boiling range streams containing low boiling sulfur compounds, comprising:
(a) contacting said naphtha boiling range stream with a high silica zeolite at effective conditions to convert at least a portion of said lower boiling sulfur compounds to higher boiling sulfur compounds;
(b) fractionating the contacted naphtha stream into a lower boiling range fraction and a higher boiling range fraction, said lower boiling range fraction boiling below about 150° C., and said higher boiling range fraction containing the higher boiling range sulfur compounds.

2. The method of claim 1 wherein the ratio of silica-to-alumina of said high silica zeolite is at least 10% greater than the base zeolite.

3. The method of claim 2 wherein the zeolites is selected from the group consisting of gmelinite, chabazite, dachiardite, clinoptilolite, faujasite, heulandite, levynite, erionite, cancrinite, scolecite, offretite, mordenite, and ferrierite.

4. The method of claim 3 wherein the zeolite has a unit cell size greater than about 6 Å in diameter.

5. The method of claim 4 wherein the zeolite is a faujasite.

6. The method of claim 1 wherein the naphtha stream to be treated has a boiling range from about 10° C. to about 230° C.

7. The method of claim 6 wherein the naphtha stream to be treated has a boiling range from about 35° C. to about 220° C.

8. The method of claim 7 wherein the naphtha stream is a catalytically cracked naphtha.

9. The method of claim 2 wherein the ratio of silica-to-alumina is at least 50% greater than that of the base zeolite.

10. The method of claim 1 wherein the lower boiling fraction boils below about 100° C.

11. The method of claim 3 wherein the naphtha is a cat cracked naphtha.

12. The method of claim 1 wherein both steps (a) and (b) are performed in a single vessel.

13. A method for reducing the level of sulfur in naphtha boiling range streams containing low boiling sulfur compounds, comprising:
(a) contacting said naphtha boiling range stream with a high silica zeolite at effective conditions to convert at least a portion of said lower boiling sulfur compounds to higher boiling sulfur compounds, wherein said zeolite has a silica-to-alumina ratio of at least about 50% greater than the base zeolites and wherein the base zeolite is selected the zeolites gmelinite, chabazite, dachiardite, clinoptilolite, faujasite, heulandite, levynite, erionite, cancrinite, scolecite, offretite, mordenite, and ferrierite;
(b) fractionating the contacted naphtha stream into a lower boiling range fraction and a higher boiling range fraction, said lower boiling range fraction boiling below about 150° C., and said higher boiling range fraction containing the higher boiling range sulfur compounds.

14. The method of claim 13 wherein the zeolite has a unit cell size greater than about 6 Å.

15. The method of claim 14 wherein the zeolites is a faujasite.

16. The method of claim 13 wherein the naphtha is a cat cracked naphtha.

17. The method of claim 13 wherein both steps (a) and (b) are performed in a single vessel.
